(19) United States
(12) Patent Application Publication
(10) Pub. No.: US 2006/0152449 A1
(43) Pub. Date: Jul. 13, 2006

(54) Active matrix display and its testing method

(76) Inventor: Hideyuki Norimatu, Tokyo (JP)

Correspondence Address: Paul D Greeley;Ohlandt Greeley Ruggiero & Perle, 10th Floor, One Landmark Square, Stamford, CT, 06901-2682, US

(21) Appl. No.: 10/538,720

(22) PCT Filed: Nov. 13, 2003
(86) PCT No.: PCT/JP03/14435

§ 371 Date: Jan. 20, 2006

(30) Foreign Application Priority Data
Dec. 16, 2002 (JP) 2002-364492
Feb. 14, 2003 (JP) 2003-36275
Feb. 28, 2003 (JP) 2003-52628

(51) Int. Cl. G09G 3/30

(52) U.S. Cl. 345/76

(57) ABSTRACT

An active-matrix display apparatus is disclosed that includes: a substrate; an electrode for provision of a display element included in each of a plurality of pixels provided on the substrate; a first transistor Q2 that is connected to the electrode and a current-source line Is (m); a second transistor Q1 that is connected to the gate of the first transistor Q2 and a data-storing signal line Data (m); a storage capacitor C1 connected to the current-source line Is (m) and the gate of the first transistor Q2; and a third transistor Qt connected to the electrode and to a gate signal line Gate (n−1) for another display element adjacent to the display element to lead current flowing from the first transistor to the electrode to the gate signal line Gate (n−1) for the other display element.

### TECHNICAL FIELD

The present invention relates to an electronic display apparatus (electro-optic apparatus) formed by fabricating electroluminescent (electroluminescence: hereinafter referred to as “EL”) elements onto a substrate. In particular, the present invention relates to a display apparatus, such as an organic EL (organic electroluminescence: or OEL) display using an active-matrix TFT (thin film transistor), and a method for inspecting the display apparatus.

### BACKGROUND ART

Active-matrix EL display apparatuses having EL elements that emit light on their own have been closely studied. The EL display apparatuses are also referred to as organic EL displays or organic light emitting diodes (organic light emitting diodes: OLEDs). The EL elements typically have a stack structure in which an EL layer is sandwiched between a pair of electrodes (an anode and a cathode). Typical examples include a stack structure that includes a hole transport layer, an emissive layer and an electron transport layer proposed by Tang, et al. of Kodak Eastman Company. Active-matrix display apparatuses using such EL elements are self light-emissive and thin can be driven with low power consumption and are thus considered to be promising candidates for next-generation displays.

For such display circuits, before the self-light-emitting organic EL elements are provided on a TFT driving circuit formed on a glass substrate, it is desired to pre-check whether or not the TFT driving circuit for each pixel is properly formed. This is because the possibility of defects is relatively high at the stage at which organic-EL-element driving circuits have been formed on the glass substrate. As a result, it is advantageous to eliminate defects at an early stage to improve the yield, etc. However, an apparatus for achieving efficient inspection with high accuracy at low cost has not been proposed.

To overcome the problems described above, a method in Japanese Unexamined Patent Application Publication No. 2002-108243 described below (Page 9, FIG. 2: hereinafter referred to as “Patent Document 1”) has been proposed. This method discloses the evaluation of circuit characteristics by depositing a film having electrical conductivity instead of organic EL elements. However, the method in Patent Document 1 requires an extra process for removing the electrically-conductive film after testing. If the electrically-conductive film cannot be fully removed, the quality of the final products can decline.

As an alternative, the pre-incorporation of a capacitor (capacitance) into the driving circuit for each circuit is disclosed in Japanese Unexamined Patent Application Publication No. 2002-297053 (Page 3, FIG. 1: hereinafter referred to as “Patent Document 2”) and Japanese Unexamined Patent Application Publication No. 2002-32035 (Pages 5 to 6, FIG. 1: hereinafter referred to as “Patent Document 3”). By way of example, a description will be given using the circuit in Patent Document 2. FIG. 20 shows an equivalent circuit for each pixel indicated by reference numeral 150 in an active-matrix display apparatus disclosed in Patent Document 2. This circuit includes a first transistor Tr1 for switching, a second transistor Tr2 for element actuation, a capacitor C1 holding data, and a capacitor C2 attached for circuit testing. The pixels use OELs as the display elements and constitute a matrix array substrate formed in a matrix on a TFT substrate. The drain terminal (D) of the first transistor Tr1 is connected to an input line of data voltage signal (Vdata), the gate terminal (G) receives a gate signal (GateSig) input from outside. The source terminal (S) of the first transistor Tr1 is connected to one terminal of the storage capacitor C1 and the gate terminal (G) of the second transistor Tr2. Another terminal of the storage capacitor C1 is connected to a Vsc line. A power-supply voltage PVdd is applied to the source terminal (S) of the second transistor Tr2. The drain terminal (D) is connected to an anode of the OEL element and one terminal of the additional capacitor C2. Another terminal of the additional capacitor C2 is connected to the Vsc line. It is to be noted that an element indicated as a diode 152 in FIG. 20 merely schematically represents the load of a light-emitting element, such as an EL element or LCD, or that of a driving circuit.

Next, the operation of the circuit shown in FIG. 20 will be briefly described. Data voltage signal corresponding to a desired gradation value is applied to the drain terminal (S) of the first transistor Tr1, and a gate signal is input to the gate terminal (G) to turn on the first transistor Tr1, so that electrical charge corresponding to the voltage of the data voltage signal is stored in the storage capacitor C1. The amount of charge stored in the storage capacitor C1 controls the electrical connection state (resistance) between the source terminal (S) and the drain terminal (D) of the second transistor Tr2. A current determined by the power-supply voltage PVdd and the controlled resistance actuates the OEL element. At this point, power is also supplied to another terminal of the additional capacitor C2, so that charge corresponding to the power is accumulated in the storage capacitor C2. Thus, the quality of the transistors are determined by checking the charge accumulated in the additional capacitor C2 to thereby check for a failure of the driving circuits for pixels on a TFT substrate.

As shown in FIG. 21, Patent Document 3 discloses an example in which, in each pixel included in an active matrix display apparatus 160 similar to the one shown in FIG. 20, a capacitor 9108 corresponding to the capacitor (or capacitance) noted above is connected to a driving electrode 9105, such as an EL element, and a gate line (G2) of a neighboring light-emitting element.

The examples of Patent Documents 2 and 3 described above, however, have the following problems. First, it is possible to check whether the driving circuit is normal or abnormal (broken down or otherwise defective), but it is difficult to accurately determine whether the circuit has a desired property, for example, whether current output by the driving circuit satisfies a design specification with respect to multiple gradation values of light-emitting elements. It is also difficult to check some properties, such as transient responses. For a circuit configuration using a capacitor, it is usually difficult to check properties for direct current and so on.

As described above, it is difficult for the conventional methods to evaluate current and voltage characteristics under display conditions actually used.

### DISCLOSURE OF THE INVENTION

The present invention is made in view of the reality described above, and an object of the present invention is to provide a display apparatus that allows easy defect-inspection under or close to actual display conditions. Specifically, the present invention provides an active-matrix display apparatus that includes: a substrate; an electrode for provision of a display element included in each of a plurality of pixels provided on the substrate; a first transistor (Q2) that is connected to the electrode and a first current-source line (Is (m)) and that determines the on or off state of the display element by using a voltage applied to the gate thereof; a second transistor (Q1) that is connected to the gate of the first transistor (Q2) and a data-storing signal line (Data (m)) and that determines a gate voltage of the first transistor by using a voltage in a gate signal line (Gate (n)) connected to the gate thereof; a storage capacitor (C1), connected to the current-source line (Is (m)) and the gate of the first transistor, for storing a voltage signal supplied from the data-storing signal line (Data (m)) via the second transistor, while the second transistor is in an on state; and a third transistor (Qt), wherein a source and a drain thereof are connected to the electrode and a gate signal line (Gate (n−1) or Gate (n+1)) for a display element other than the display element, and a gate thereof is controlled such that current flowing from the first transistor to the electrode is led to the gate signal line (Gate (n−1) or Gate (n+1)) for the other display element.

Here, preferably, the gate of the third transistor is connected to a second current-source line (Is (m+1)) for the display element other than the display element to thereby perform control such that the gate is put into an on state or off state. Preferably, the gate of the third transistor is connected to the gate signal line (Gate (n−1) or Gate (n+1)) for the other display element to thereby perform control such that the gate is put into an on state or an off state.

The present invention further provides an active-matrix display apparatus that includes: a substrate; an electrode for provision of a display element included in each of a plurality of pixels provided on the substrate; a first transistor (Q2) that is connected to the electrode and a first current-source line (Is (m)) and that determines an on state or an off state of the display element by using a voltage applied to a gate thereof; a second transistor (Q1) that is connected to the gate of the first transistor (Q2) and a data-storing signal line (Data (m)) and that determines a gate voltage of the first transistor by using a voltage in a gate signal line (Gate (n)) connected to a gate thereof; a storage capacitor (C1), connected to the current-source line (Is (m)) and the gate of the first transistor, for storing a voltage signal supplied from the data-storing signal line (Data (m)) via the second transistor, while the second transistor is in an on state; and a third transistor (Qt), wherein a source and a drain thereof are connected to the electrode and the gate signal line (Gate (n)), and a gate thereof is put into an on state or an off state by changing a potential of a gate signal line (Gate (n+1)) for a display element other than the display element, so that current flowing from the first transistor to the electrode is led to the gate signal line (Gate (n)).

Here, preferably, the display element is an organic EL element. Preferably, the gate of the third transistor is connected to a power-source supply line (Gate (Common)) that is additionally provided. Preferably, the gate of the third transistor is connected to a current-releasing line (Drain (n)) that is additionally provided. Preferably, the third transistor is p-type. Preferably, a line from the third transistor is connected to a peripheral circuit for simultaneously controlling two or more of the display elements when the display apparatus is in an operation state, and the third transistors are sequentially switched via the peripheral circuit.

The present invention also provides a method for inspecting any of the display apparatuses. Specifically, the present invention provides a method for inspecting each display element of any of the active-matrix display apparatuses described above. The method includes a step of storing charge into the storage capacitor (C1) by controlling a gate voltage of the second transistor (Q1); a step of controlling the gate of the third transistor (Qt) by changing a potential of a first line for a display element other than the display element to be inspected; and a step of measuring an amount of charge or current flowing from the electrode via the third transistor (Qt), by using a measuring unit connected to the first current-source line for the display element to be inspected.

The present invention also provides second display apparatuses that allow easy defect-inspection according an actual display state. Specifically, the present invention provides a display apparatus that includes: a substrate; an electrode for provision of a display element included in each of a plurality of pixels provided on the substrate; a first transistor (Q2) that is connected to the electrode and a current-source line (Is (m)) and that determines on or off state of the display element by using a voltage applied to a gate thereof; a second transistor (Q1) that is connected to the gate of the first transistor (Q2) and a data-storing signal line (Data (m)) and that determines a gate voltage of the first transistor by using a voltage in a gate signal line (Gate (n)) connected to a gate thereof; a storage capacitor (C1), connected to the current-source line and the gate of the first transistor, for storing a signal supplied from the data-storing signal line (Data (m)) via the second transistor, while the second transistor is in an on state; and a diode (Dt) connected to the electrode (ITO) and to a gate signal line (Gate (n+1) or Gate (n−1)) for a display element other than the display element.

Here, preferably, the display element is an organic EL element. Preferably, the diode is connected to a current-releasing line (Drain (n)) that is additionally provided.

The present invention also provides a method for inspecting any of the second display apparatuses described above. Specifically, the present invention provides a method for inspecting each pixel of any of the active-matrix display apparatuses described above. The method includes a step of storing charge into the storage capacitor (C1) by controlling the gate of the second transistor (Q1); and a step of measuring an amount of charge or current flowing from the electrode via the diode (Dt), by changing a potential of a first line for a display element other than the display element to be inspected and using a measuring unit connected to a second line for the display element other than the display element to be inspected.

In addition, the present invention provides third display apparatuses that allow easy defect-inspection according to an actual display state. Specifically, the present invention provides an active-matrix display apparatus in which each pixel included in the display apparatus includes: an electrode connected to a display element for the pixel; a first transistor (Q2) connected to the electrode and to a first line (Is) for the pixel; a second transistor (Q1) connected to a gate of the first transistor and to a data-storing signal line (Data (m)) for supplying a voltage signal; a storage capacitor (C1) connected to the gate of the first transistor and to a second line (Common) for the pixel, and a load capacitor (Cfb) connected to the electrode and the gate of the first transistor such that charge is accumulated by current flowing from the first transistor to the electrode.

Here, preferably, the display element is an organic EL element.

The present invention further provides a method for inspecting any of the third display apparatuses. Specifically, the present invention provides a method for inspecting each pixel of any of the active-matrix display apparatuses described above. The method includes a step of supplying a first voltage (V1) to the first transistor (Q2); a step of storing charge into the storage capacitor (C1) and the load capacitor (Cfb), by temporarily turning on and turning off the second transistor (Q1) through control of the gate signal line (Gate (n)) connected to the gate of the second transistor to thereby apply a voltage of the data-storing signal line (Data (m)) to the gate of the first transistor (Q2); a step of reducing the first voltage (V1); a step of measuring an amount of charge stored in the storage capacitor (C1), by turning on the second transistor (Q1) and using a charge measuring unit connected to the data-storing signal line (Data (m)); a step of obtaining, in each pixel, a difference between the amount of measured charge and an amount of charge when the first voltage is supplied; and a step of determining whether the difference is in a predetermined range.

Here, in the step of reducing the first voltage (V1), preferably, the first voltage is reduced to a predetermined voltage that is lower than the voltage of the electrode in the step of storing the charge. Preferably, the method further includes a step of pre-resetting the amount of charge stored in the storage capacitor (C1), prior to the step of supplying the first voltage (V1) to the first transistor (Q2). In the step of reducing the first voltage (V1), preferably, the first voltage is reduced until the first transistor is turned off by a threshold voltage of the first transistor (Q2).

Moreover, the present invention provides fourth display apparatuses that allow easy defect-inspection according to an actual display state. Specifically, the present invention provides an active-matrix display apparatus that includes: a substrate; an electrode for provision of a display element included in each of a plurality of pixels provided on the substrate; a first transistor (Q2) connected to the electrode and to a current-source line (Is (m)); a second transistor (Q1) connected to a gate of the first transistor (Q2) and to a data-storing signal line (Data (m)), a gate signal line (Gate (n)) being connected to a gate thereof; a storage capacitor (C1) connected to the gate of the first transistor (Q2) and to the current-source line (Is (m)); and a load capacitor (Ct) connected to the electrode and to a line (Gate (n−1)) connected to the gate of the second transistor (Q1) of another display element such that charge is accumulated by current flowing when the first transistor (Q2) is turned on.

The present invention further provides an active-matrix display apparatus that includes: a substrate; an electrode for provision of a display element included in each of a plurality of pixels provided on the substrate; a first transistor (Q2) connected to the electrode and to a current-source line (Is (m)); a second transistor (Q1) connected to a gate of the first transistor (Q2) and to a data-storing signal line (Data (m)), a gate signal line (Gate (n)) being connected to a gate thereof; a storage capacitor (C1) connected to the gate of the first transistor (Q2) and to the current-source line (Is (m)); and a load capacitor (Ct) connected to the electrode and to the gate of the second transistor (Q1) of the same display element and connected to the gate signal line (Gate (n)) such that charge is accumulated by current flowing when the first transistor (Q2) is turned on.

Here, preferably, the display element is an organic EL element.

The present invention further provides a method for inspecting any of the fourth display apparatuses. Specifically, the present invention provides a method for inspecting each display element of any of the fourth active-matrix display apparatuses described above. The method includes a step of storing charge into the storage capacitor (C1) by controlling the gate of the second transistor (Q1); and a step of measuring an amount of charge or current flowing from the electrode, by changing a potential of a gate signal (Gate (n+1)) line for a display element other than the display element to be inspected and using a measuring unit connected to the current-source line (Is (m)) for the display element to be inspected.

With respect to any of the active-matrix display apparatuses according to the aspects described above, the present invention provides an active-matrix display apparatus in which the other display element is adjacent to the display element to be inspected. Further, with respect to any of the active-matrix display apparatuses according to the aspects described above, the present invention further provides a method for inspecting the active-matrix display apparatus in which the other display element is adjacent to the display element to be inspected.

In addition, the present invention provides fifth display apparatuses that allow easy defect-inspection in which current measurement can be performed according to an actual display state, by performing writing to a pixel of interest to simultaneously form a current measuring circuit.

Specifically, the present invention provides an active matrix display apparatus that includes: a substrate; an electrode for provision of a display element included in each of a plurality of pixels provided on the substrate; a first transistor that is connected to the electrode and a first current-source line and that determines on or off state of the display element by using a voltage applied to a gate thereof; a second transistor that is connected to the gate of the first transistor and a data-storing signal line and that determines a gate voltage of the first transistor by using a voltage in a gate signal line connected to a gate thereof; and a third transistor, wherein a drain thereof is connected to the electrode and a source and a gate thereof are connected to the gate signal line for the display element, so that current flowing from the first transistor to the electrode is led to the gate signal line for the display element.

The present invention further provides an active-matrix display apparatus that includes: a substrate; an electrode for provision of a display element included in each of a plurality of pixels provided on the substrate; a first transistor that is connected to the electrode and a current-source line and that determines on or off state of the display element by using a voltage applied to a gate thereof; a second transistor that is connected to the gate of the first transistor and a data-storing signal line and that determines a gate voltage of the first transistor by using a voltage in a gate signal line connected to a gate thereof; and a diode connected to the electrode and to the gate signal line for the display element.

The present invention also provides an inspection method using any of the fifth display apparatuses described above. Specifically, the present invention provides a method for inspecting each display element of any of the display apparatuses described above. The method includes a step of controlling a gate voltage of the second transistor by changing a potential of the gate signal line for the display element to be inspected, supplying a voltage determined by the data-storing signal line to the gate of the first transistor, and controlling the gate of the third transistor or the diode; and a step of measuring an amount of charge or current flowing from the electrode via the third transistor or the diode, by using a measuring unit connected to the gate signal line or the first current-source line.

The present invention provides sixth display apparatuses that allow easy defect-inspection in which current measurement can be performed according to an actual display state, by performing writing to a pixel of interest to simultaneously form a current measuring circuit.

Specifically, the present invention provides an active matrix display apparatus that includes: a substrate; a substrate; an electrode for provision of a display element included in each of a plurality of pixels provided on the substrate; a first transistor that is connected to the electrode and a first current-source line and that determines on or off state of the display element by using a voltage applied to a gate thereof; a second transistor that is connected to the gate of the first transistor and a data-storing signal line and that determines a gate voltage of the first transistor by using a voltage in a gate signal line connected to a gate thereof; a third transistor, wherein a gate and a drain thereof are connected to the electrode and a gate line for a display element other than the display element, and a gate thereof is controlled such that current flowing from the first transistor to the electrode is led to a gate signal line for the other display element. Here, preferably, the gate of the third transistor is connected to the gate line for the display element, to thereby perform control such that the gate is put into an on state or an off state.

The present invention further provides a method for inspecting each display element of any of the sixth display apparatuses. The method includes a step of controlling a gate voltage of the second transistor by changing a potential of the gate signal line for the display element to be inspected, supplying a voltage determined by the data-storing signal line to the gate of the first transistor, and controlling the gate of the third transistor; and a step of measuring current flowing from the electrode via the third transistor, by using a measuring unit connected to the first current-source line for the display element to be inspected or to the gate signal line for the display element other than the display element to be inspected.

As the transistors used in the display apparatuses described above, either p-type transistors or n-type transistors may be used when the type is not particularly limited.

The present invention is commonly applied to testing of a display apparatus formed on a substrate having an electrode and a driving device for a display element corresponding to each pixel, and is not necessarily limited to a display apparatus of a type in which a now-dominant transparent electrode is used to allow viewing from the substrate side. Thus, the present invention is also directed to a display apparatus that allows viewing from a light-emitting material or opposing electrode provided on a substrate having an electrode and a driving device. The electrode provided on the substrate, therefore, is not limited to a transparent electrode.

In the display apparatus described above, it is preferable that the opening area of the self-emissive organic EL element be designed to be as large as possible, i.e., the area of the electrode be designed to be as large as possible. Thus, it is preferable that an element that is incorporated for evaluation corresponding to each pixel has as small an area as possible. It is also preferable that independent wiring be provided for each display element so that a group of display elements corresponding to individual elements can be separately measured to thereby improve the resolution of current/voltage measurement.

All layers provided between the cathode and the anode are generally referred to as an EL layer. The EL layer, therefore, can include a hole injection layer, hole transport layer, emissive layer, electron transport layer, and electron injection layer. Herein, a light-emitting element formed by an anode, an EL layer, and a cathode is referred to as an EL element. The EL element in the present invention can include both a type utilizing light emission (fluorescence) from a singlet exciton and a type utilizing light emission (phosphorescence) from a triplet exciton.

### BRIEF DESCRIPTION OF THE DRAWINGS

FIG. 1 is a schematic diagram of an active-matrix display apparatus of the present invention, wherein A to C show cases in which a transistor (Qt) is used, D to E show cases in which a diode (Dt) is used, and F shows a case in which a capacitor (Ct) is used.

FIG. 2 is a circuit diagram showing a circuit on a substrate of an active-matrix display apparatus corresponding to A of FIG. 1 and according to a first embodiment of the present invention.

FIG. 3 is a circuit diagram showing a circuit on a substrate of an active-matrix display apparatus corresponding to B of FIG. 1 and according to a second embodiment of the present invention.

FIG. 4 is a circuit diagram showing a circuit on a substrate of an active-matrix display apparatus corresponding to C of FIG. 1 and according to a third embodiment of the present invention.

FIG. 5 is a circuit diagram showing a form in which the drain and source of a transistor Qt are interconnected in the circuit on the substrate of the active-matrix display apparatus according to the first embodiment of the present invention which is shown in FIG. 4.

FIG. 6 is a circuit diagram showing a form in which the drain and gate of the transistor Qt are interconnected and its connection end is connected to a gate line Gate (n) of the display pixel, in the circuit on the substrate of the active matrix display apparatus according to the first embodiment of the present invention which is shown in FIG. 5.

FIG. 7 is a circuit diagram showing a form in which the connection end of the drain and gate of the transistor Qt is changed in the circuit on the substrate of the active matrix display apparatus according to the first embodiment of the present invention which is shown in FIG. 4.

FIG. 8 is a circuit diagram showing a form in which the connection end of the drain and gate of the transistor Qt is opposite to that in FIG. 7, in the circuit on the substrate of the active matrix display apparatus shown in FIG. 7.

FIG. 9 is a circuit diagram showing a circuit on the substrate of an active-matrix display apparatus corresponding to D of FIG. 1 and according to a fourth embodiment.

FIG. 10 is a circuit diagram showing, in the circuit on the substrate of the active matrix display apparatus corresponding to FIG. 9 and according to the fourth embodiment of the present invention, a form in which its connection end is connected to the gate line Gate (n) of the display pixel.

FIG. 11 is a circuit diagram showing a circuit on the substrate of an active-matrix display apparatus corresponding to E of FIG. 1 and according to a fifth embodiment of the present invention.

FIG. 12 is a circuit diagram of an active-matrix display apparatus according to a sixth embodiment in which an additional feedback capacitor (Cfb) is added.

A of FIG. 13 is a schematic diagram of a pixel driving circuit when n-type transistors are used as the Q1 and Q2 in the sixth embodiment shown in FIG. 12.

B of FIG. 13 is a timing chart for illustrating the operation of the voltage-driven-type circuit in A of FIG. 13.

A of FIG. 14 is a schematic diagram of a pixel driving circuit for a case in which an n-type transistor is used as Q1 and a p-type transistor is used as Q2.

B of FIG. 14 is a timing chart for illustrating the operation of the current-driven-type circuit in A of FIG. 14.

FIG. 15 is a circuit diagram showing a seventh embodiment, in which the diode Dt in the embodiment shown in FIG. 9 is replaced with a capacitor Ct, according to the present invention corresponding to F of FIG. 1.

FIG. 16 is a circuit diagram showing an embodiment, in which the capacitor Ct in the circuit shown in FIG. 1 is connected to the gate line in question Gate (n), according to the present invention.

A of FIG. 17 is a schematic diagram showing a driving circuit for the pixel of interest shown in FIG. 15.

B of FIG. 17 is a timing chart for illustrating the operation of the circuit shown in FIG. 17A.

FIG. 18A is a schematic diagram showing a driving circuit in which an n-type transistor is used for the transistor Q1 and a p-type transistor is used for the transistor Q2 in the pixel of interest shown in FIG. 16.

FIG. 18B is a timing chart for illustrating the operation of the circuit shown in FIG. 18A.

A of FIG. 19 is a schematic diagram showing a driving circuit in which n-type transistors are used for the transistors Q1 and Q2 in the pixel of interest shown in FIG. 16.

B is a timing chart for illustrating the operation of the circuit in A of FIG. 19.

FIG. 20 is a circuit diagram showing an equivalent circuit for each pixel in a conventional active-matrix display apparatus using capacitors.

FIG. 21 is a circuit diagram showing the circuit configuration of a pixel section of a conventional active-matrix display apparatus using capacitors.

### BEST MODE FOR CARRYING OUT THE INVENTION

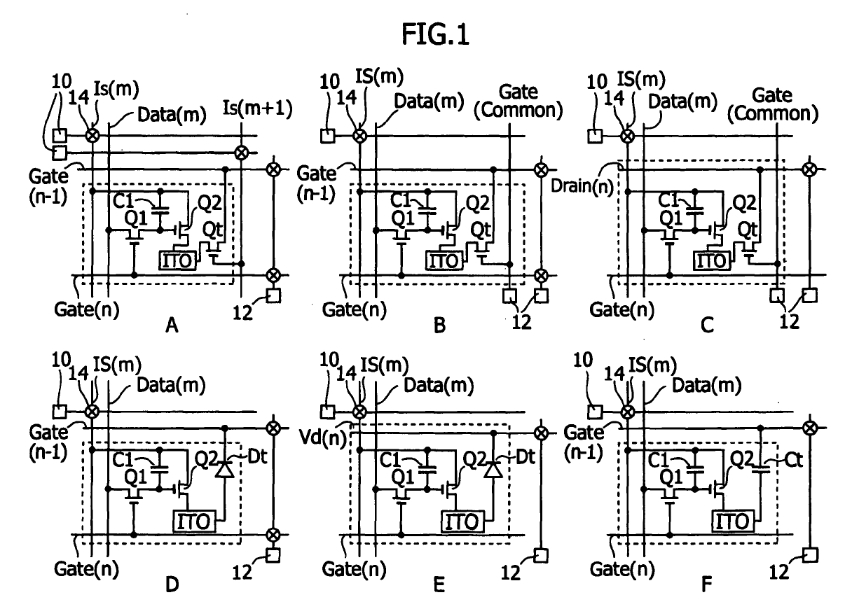

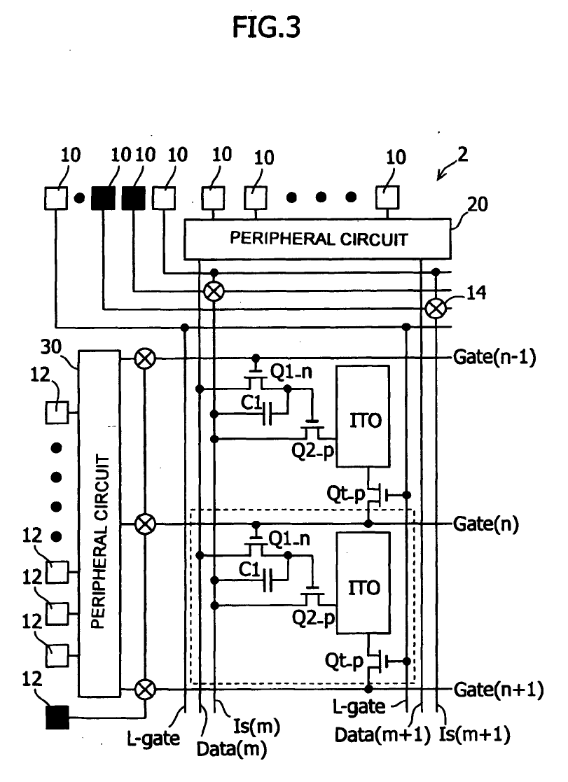

Some embodiments of the present invention will first be described with reference to FIG. 1. FIG. 1 shows, in the pixel peripheral portion, some types and connections of load element connected to an electrode to cause light-emitting or driving of an element, such as an EL display or liquid crystal display (LCD). The examples here illustrate cases in which the so-called ITO electrode, i.e., a transparent electrode formed by evaporating indium and tin oxide onto a substrate containing glass or the like, is employed. Thus, the electrode on the substrate is simply indicated as “ITO”, particularly in the figure. The present invention, however, is not limited to a transparent electrode, such as an ITO electrode, and is commonly applicable to a display apparatus manufactured by forming electrodes and driving circuits, including transistors, on a substrate. As a load element, FIGS. 1A to 1C each show a form using a transistor (Qt), FIGS. 1D and 1E each show a form using a diode (Dt), and FIG. 1F shows a form using a capacitor (Ct). Portions surrounded by dotted lines in FIGS. 1A to 1F show a driving circuit for one pixel included in an active-matrix display apparatus. Also, portions surrounded by dotted lines in FIGS. 3 to 12, 15, and 16 illustrated below similarly show a driving circuit for one pixel included in an active matrix display apparatus.

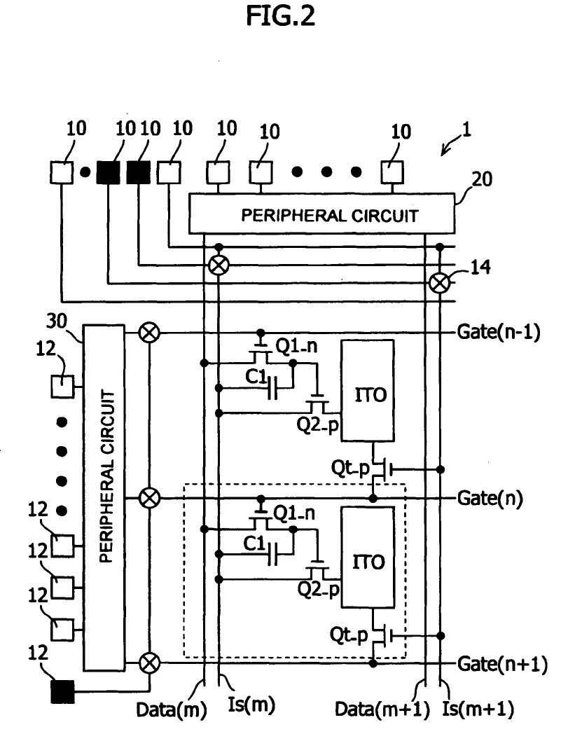

Next, a basic circuit configuration of a display apparatus using the transistor (Qt) as a load element for the driving circuit of the present invention will be described with reference to FIG. 1A. In FIG. 1A, the driving circuit for the pixel included in the active-matrix display apparatus includes an electrode, a first transistor (Q2), a second transistor (Q1), a storage capacitor (C1), and a third transistor (Qt). The electrode is connected to an EL element and so on and typically is made of electrically conductive, transparent ITO. The first transistor (Q2) is connected to that electrode and a current-source line (Is(m)) for the pixel and switches between the on state and off state of the EL element and so on in accordance with a voltage applied to the gate thereof. The second transistor (Q1) is connected to the gate of the first transistor (Q2) and a data-storing signal line (Data(m)) for supplying a voltage signal, and switches between the on state and off state of the first transistor (Q2) in accordance with a voltage applied to the gate thereof. The storage capacitor (C1) is connected to the current-source line (Is(m)) and the gate of the first transistor (Q2), and stores a voltage signal for data supplied via the second transistor (Q1), while the second transistor (Q1) is in the on state. The third transistor (Qt) is connected to the electrode and a line (Gate(n−1)) for a pixel other than the pixel of interest or a line (Gate(n−1)) for an adjacent pixel, and puts the gate into the on state or off state by changing the potential of a line (Is(m+1)) for the other pixel, to thereby lead current which flows from the first transistor (Q2) to the electrode to the line for the other pixel. In the peripheral portion of the pixels, pads 10 and 12 connected to peripheral circuits 20 and 30, a switch 14 for turning on or off a power supply for each pixel, and so on are arranged. FIG. 2 shows a more detailed circuit than the one shown in FIG. 1A and includes such peripheral circuits 20 and 30 and so on.

Here, the above-described circuit of the present invention is different from the conventional circuit in that the third transistor Qt described above is added as a load element. Also, the present invention is further applicable to a case in which the transistor Qt portion is changed to a diode Dt or a capacitor Ct, as described below.

When the transistor Qt, the diode Dt, or the capacitor Ct, which is a load element, is added, it is preferable that the first transistor (Q2) and the above-mentioned load element be connected via the electrode so that the state of connection between the electrode and the transistor Q2 can also be checked.

Next, the operation of a circuit using the transistor shown in FIG. 1A will be described with reference to FIG. 2. The portion surrounded by the dotted line shown in FIG. 2 corresponds to the portion surrounded by the dotted line in FIG. 1A. In the figures herein, reference symbols denoted by _n refer to an n-type transistor and those denoted by _p refer to a p-type transistor. First, the gate voltage of the transistor (Q2) is controlled to control the amount of current to the electrode (ITO electrode). In this case, a desired voltage is obtained for a line Data (m), and a line Gate (n) is used for control to temporarily turn on the Q1 and turn it off, so that charge is accumulated in the capacitor C1 for data storage. Next, the voltage at the capacitor C1 is maintained until the state is changed. Thus, in this state, if an EL element is formed in this state, power is supplied to the EL element and so on (not shown) via the electrode to cause light emission.

Next, a current-source line for a pixel other than the pixel of interest, for example, a current-source line Is (m+1) adjacent to the pixel of interest, is used to control the gate of the transistor (Qt) to connect the drain of the transistor (Qt) to a gate line Gate (n+1) adjacent to the pixel of interest. Subsequently, an ammeter (not shown) connected to the line Is (m) is used to measure current flowing through the electrode (i.e., current following through the EL element).

In the embodiment shown in FIG. 1A or 2, it is preferable that the transistor Qt be p-type. This is because it is preferable that the current flowing through the transistor Qt be turned off when the gate voltage and source voltage of the transistor Q2 are zero, in order to prevent a failure in that current supplied, for EL-light emission, from the transistor Q2 flows out via the transistor Qt when the EL element is actually caused to emit light (or is driven). Here, when p-type transistors are also used for the transistors Q1 and Q2, all transistors including the transistor Qt can be configured as p-type transistors.

In this case, when an n-type transistor is used for the transistor Q2, the driving circuit serves to set a voltage for the electrode, and when a p-type transistor is used for the transistor Q2, the driving circuit serves to set current for the (ITO) electrode. In either case, the operation principles are the same.

A second embodiment of the present invention, which embodiment is an improvement of the first embodiment, will be described next with reference to FIG. 3. In the first embodiment described above, the transistor Qt is controlled by the current-source line (Is(m+1)) of another pixel, for example, an adjacent pixel. In the second embodiment, however, a line L_gate (corresponding to Gate (common) shown in FIG. 1B), which is an additional power-source supply line, is provided to control the transistor Qt. As in the case described above, with respect to the line L_gate, which is an additional power-source supply line, voltage control and so on can also be performed from the peripheral circuits. Thus, the restrictions on the transistor Qt in the first embodiment can be eliminated and also an n-type transistor can be used for the transistor Qt.

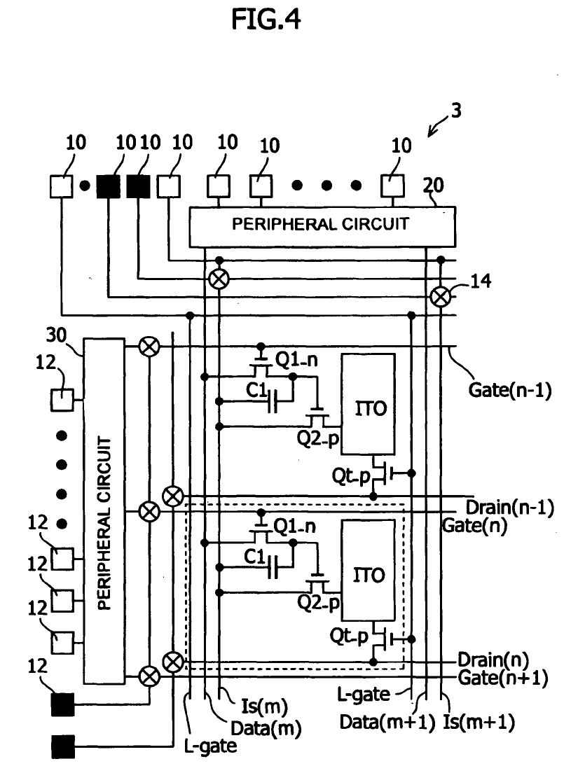

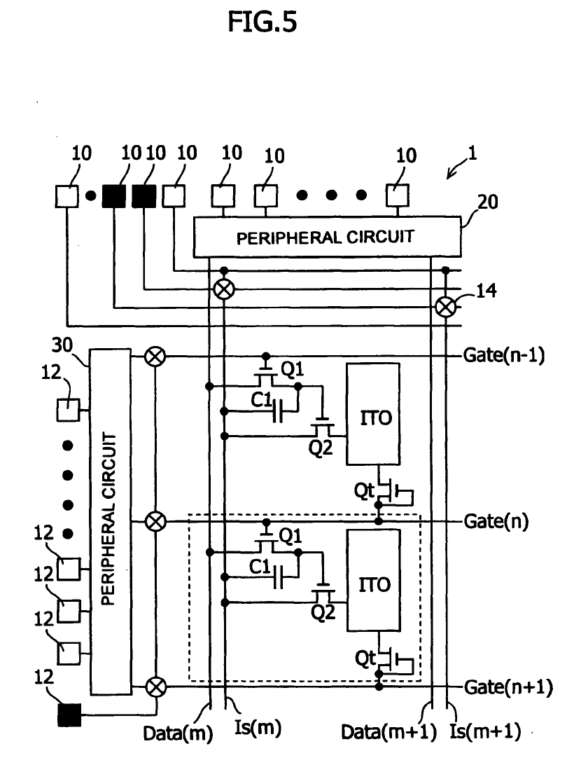

A third embodiment of the present invention will further be described with reference to FIG. 4. In the third embodiment, a current releasing line, i.e., a Drain (n) line, is added, as an additional line, to the second embodiment. An output of the transistor Qt is connected to the additional line Drain (n). Connecting an ammeter (not shown) to the current-source line (Is (m)) or the additional line Drain (n) allows current flowing through the electrode to be measured, as in the first and second embodiments.

In this case, there is no need to use the gate line for another pixel, for example, the gate line Gate (n−1) or Gate (n+1) of an adjacent pixel in order to measure current flowing through the electrode. This provides advantages in that restrictions during current measurement are eliminated and measurement freedom is increased.

Instead of providing the current-source line (Is (m+1)) for a pixel other than the pixel of interest shown in FIG. 2, the arrangement can also be such that the drain of the transistor Qt and the gate of the transistor Qt are connected and a line connected to the drain and gate of the transistor Qt is connected to the gate line Gate (n) for driving the pixel or the gate line Gate (n+1) or Gate (n−1) for driving an adjacent pixel. This case is shown in FIG. 5. This configuration is applicable to a case in which the transistors Q1 and Qt are p-type. In this case, when the gate line of connection end of the transistor Qt is selected and the voltage goes low, the transistor Qt is turned on. Thus, this configuration can be used in the same manner as the case in which the transistor Qt is a diode.

Next, a method for evaluating the current characteristic will be described with reference to FIG. 5. First, the gate voltage of the transistor Q2 is controlled to control the amount of current to the electrode. In this case, a desired voltage is obtained for the voltage-signal line Data (m) for storing data for the pixel of interest, the voltage in the gate line Gate (n) of the pixel of interest is caused to go low, and the transistor Q1 is temporarily turned on and then turned off, so that charge is stored in the data storing capacitor C1. Next, the voltage is stored in the capacitor C1 until the state is changed. Thus, if an EL element is formed at the electrode in this state, power is supplied to the EL element and so on (not shown) via the electrode. As a result, the electrons and holes are recombined in the EL element, so that the EL element continues to be driven or to emit light.

Subsequently, the gate line Gate (n+1) of a pixel other than the pixel of interest, for example, the gate line Gate (n+1) of an adjacent pixel, causes the gate voltage at the transistor Qt to go low, thereby turning on the transistor Qt, so that current flowing in the transistor Qt flows to the Gate (n+1) via the transistor Q2. At this point, an ammeter (not shown) connected to the current-source line Is (m) line is used to measure current flowing through the electrode (i.e., current flowing through an EL element, when it is formed)).

With this arrangement, after an operation for turning on and off the transistor Q1 using the Data (m) and the Gate (n), i.e., an operation for performing writing to the pixel of interest, the value of current flowing through the pixel of interest can be evaluated when the voltage of the Gate (n+1) is caused to go low and a data signal is written to a pixel other than the pixel of interest, for example, to an adjacent pixel. In other words, controlling the gate line of a pixel other than a pixel of interest or the gate line of an adjacent pixel allows measurement of an electrical characteristic of the driving circuit for the pixel of interest that is in a hold state.

Here, while the gate line Gate (n+1) of a pixel other than the pixel of interest is used in the measurement described above, the current-supply line Is (m+1) of the other pixel is not used. Thus, the control is simple and loads on the circuit design of elements are reduced.

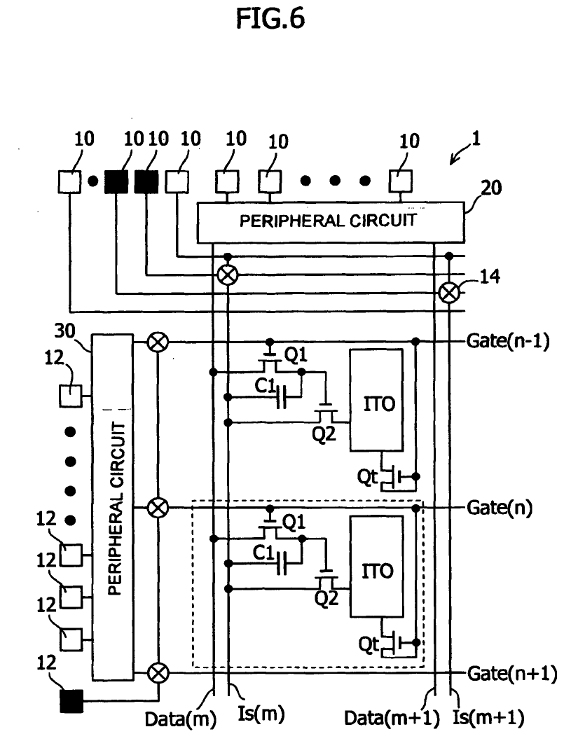

Next, FIG. 6 shows a case in which, instead of providing the current-source line (Is (m+1)) of a pixel other than the pixel of interest, the drain of the transistor Qt and the gate of the transistor Qt are connected and a line connected to the drain and gate of the transistor Qt is connected to the gate line Gate (n) for driving the pixel. This configuration is applicable to a case in which the transistors Q1 and Qt are p-type. In this case, when the gate line of connection end of the transistor Qt is selected and the voltage goes low, the transistor Qt is turned on. Thus, this configuration can be used in the same manner as the case in which the transistor Qt is a diode.

Next, a method for evaluating the current characteristic will be described with reference to FIG. 6. First, the gate voltage of the transistor Q2 is controlled to control the amount of current to the electrode. That is, a desired voltage is obtained for the voltage-signal line Data (m) for storing data for a pixel of interest, and the voltage in the gate line Gate (n) of the pixel of interest is caused to go low, thereby turning on the transistor Q1. As a result, the voltage determined by the voltage-signal line Data (m) is supplied to the gate of the transistor Q2. At this point, charge is also stored in the capacitor C1. Thus, in this state, if an EL element is formed at the electrode, power is supplied to the EL element and so on (not shown) via the electrode. As a result, the electrons and holes are recombined in the EL element, so that the EL element continues to be driven or to emit light.

This means that an electrical characteristic of the transistor (Q2) for driving the electrode of a pixel of interest can be measured based on the Q2 gate voltage determined by the Data (m). This measurement provides an advantage in that, for example, setting at least two setting voltage values for the Data (m) and measuring current flowing after a certain waiting time using an ammeter allows detailed measurement of the current characteristic of the transistor (Q2), the characteristic being different from the hold-state characteristic a pixel of interest. Here, the ammeter is connected to the current-source line Is (m) of the pixel of interest or the gate line Gate (n) of the pixel of interest. Since this measurement does not use any line of another pixel, the control is simple and loads during the circuit design of elements are reduced.

This transistor (Qt) is turned on when writing to the pixel of interest is performed. The transistor (Qt) can be provided, as a TEG (test element group) for pixel process-management, on a display apparatus, to be used for evaluation of the display apparatus. A pixel including the test circuit can be used together with a pixel including another test circuit.

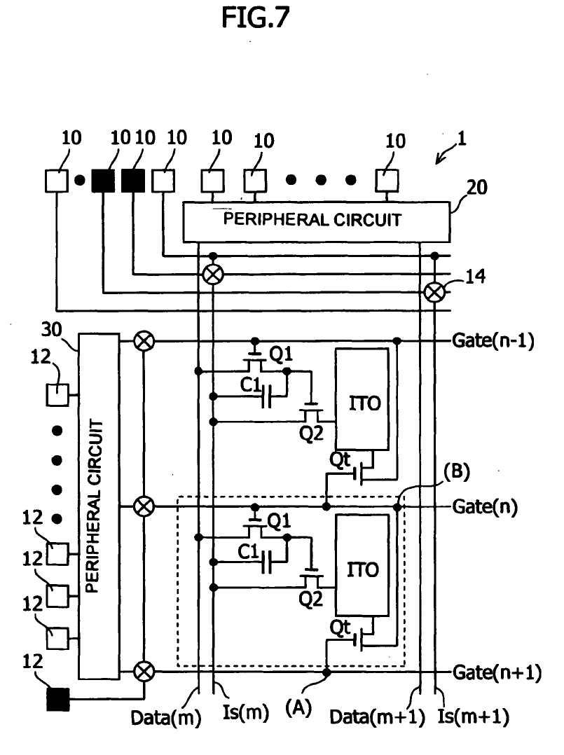

In addition, as shown in FIG. 7, the arrangement can be such that, instead of providing the current-source line (Is (m+1)) of a pixel other than the pixel of interest shown in FIG. 2, the gate of the transistor Qt is connected to, as indicated by a contact (A), the gate line for driving a pixel other than the pixel of interest, for example, the gate line Gate (n+1) for driving an adjacent pixel, and the source of the transistor Qt is connected to, as indicated by a contact (B), another gate line Gate (n) for driving the pixel. The configuration of FIG. 7 is applicable to a case in which the transistor Q1 and the transistor Qt are n-type.

A method for measuring the electrical characteristic will be described next with reference to FIG. 7. First, the gate voltage of the transistor Q2 is controlled to control the amount of current to the electrode. This is achieved by obtaining a desired voltage to the voltage signal line Data (m) for storing a voltage for a pixel of interest, causing a voltage in the gate line Gate (n) of the pixel of interest to go high, and temporarily turning on the transistor Q1 and then turning it off so that charge is stored in the data-storing capacitor C1. Next, the voltage at the capacitor C1 is maintained until the state is changed. Thus, if an EL element is formed in this state, power is supplied to the EL element and so on (not shown) via the electrode. As a result, the electrons and holes are recombined in the EL element, so that the EL element continues to be driven or to emit light.

Subsequently, the gate line Gate (n+1) of a pixel adjacent to the pixel of interest causes the gate voltage at the transistor Qt to go high, thereby turning on the transistor Q2, so that current flowing in the transistor Qt flows to the Gate (n) via the transistor Q2. At this point, an ammeter (not shown) connected to the line Is (m) is used to measure current flowing through the electrode, i.e., current that would flow through an EL element if it were formed.

With this arrangement, after an operation for turning on and off the transistor Q1 using the Data (m) and the Gate (n), i.e., an operation for performing writing to the pixel of interest, the value of current flowing to the pixel of interest can be evaluated when the voltage in the Gate (n+1) is caused to go high and a data signal is written to its adjacent pixel. In other words, controlling the gate line of a pixel adjacent to a pixel of interest allows measurement of an electrical characteristic of the driving circuit for the pixel of interest that is in a hold state.

This measurement uses the gate line Gate (n+1) of an adjacent pixel, but does not use the power-supply line Is (m+1) of an adjacent pixel. Thus, the control is simple and loads on the circuit design of elements are reduced.

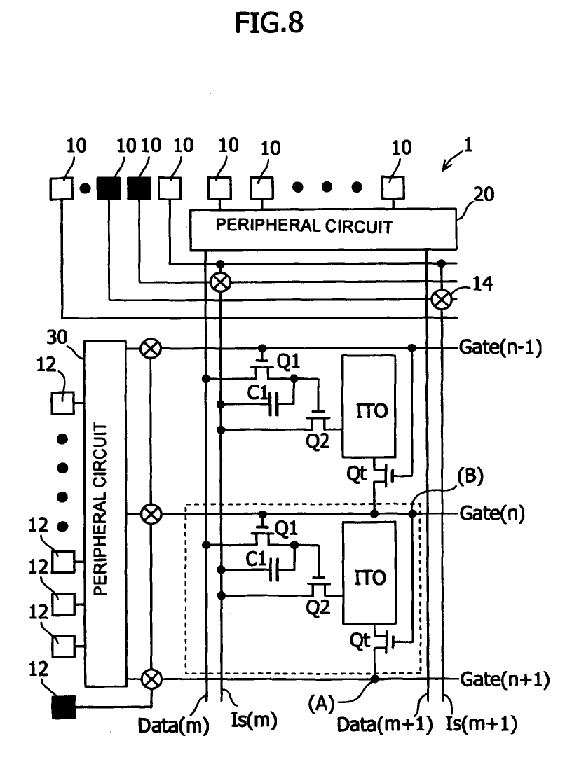

In addition, as shown in FIG. 8, the arrangement can be such that, instead of providing the current-source line (Is (m+1)) of a pixel other than the pixel of interest shown in FIG. 2, the gate of the transistor Qt is connected to, as indicated by a contact (B), the gate line Gate (n) for driving the same pixel as the pixel of interest, and the source of the transistor Qt is connected to, as indicated by a contact (A), another gate line Gate (n+1) for driving the pixel. The configuration of FIG. 8 is applicable to a case in which the transistor Q1 and the transistor Qt are n-type.

Next, a method for measuring its electrical characteristic will be described with reference to FIG. 8. First, the gate voltage of the transistor Q2 is controlled to control the amount of current to the electrode. That is, a desired voltage is obtained for the voltage-signal line Data (m) for storing data for a pixel of interest and the voltage in the gate line Gate (n) of the pixel of interest is caused to go high, thereby turning on the transistor Q1. As a result, the voltage determined by the voltage-signal line Data (m) is supplied to the gate of the transistor Q2. At this point, charge is also stored in the capacitor C1. Thus, in this state, if an EL element is formed at the electrode, power is supplied to the EL element and so on (not shown) via the electrode. As a result, the electrons and holes are recombined in the EL element, so that the EL element continues to be driven or to emit light.

This means that an electrical characteristic of the transistor (Q2) for driving the electrode of a pixel of interest can be measured based on the Q2 gate voltage determined by the Data (m). This measurement provides an advantage in that, for example, setting at least two setting voltage values for the Data (m) and measuring current flowing after a certain waiting time using an ammeter allows detailed measurement of a current characteristic of the transistor (Q2), the characteristic being different from the hold-state characteristic of a pixel of interest. Here, the ammeter is connected to the current-source line Is (m) of the pixel of interest or the gate line Gate (n) of the pixel of interest. Since this measurement does not use any line of another pixel, the control is simple and loads during the circuit design of elements are reduced.

This transistor (Qt) is turned on when writing to the pixel of interest is performed. The transistor (Qt) can be provided, as a TEG for pixel process-management, on a display apparatus, to be used for evaluation of the display apparatus. A pixel including the test circuit can be used together with a pixel including another test circuit.

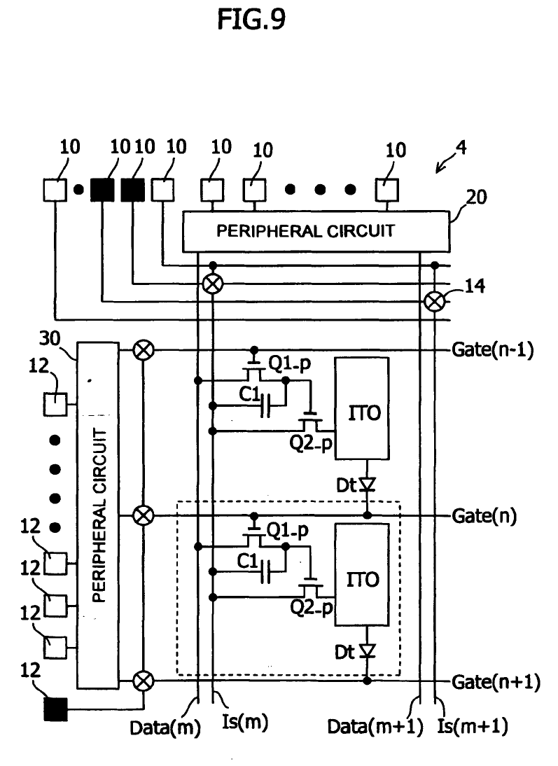

While the driving circuit using the transistor Qt and the method for inspecting the circuit using the driving circuit have been described above, a fourth embodiment of the present invention using a diode instead of the transistor Qt will be described next with reference to FIG. 9. The fourth embodiment has a configuration that is substantially the same as the configuration in which the transistor Qt in the first embodiment shown in FIG. 2 is replaced with a diode Dt. When compared to the case of the three-terminal-element transistor Qt, the diode is a two-terminal element, which does not require a line and so on for controlling the gate. Thus, the circuit has a somewhat simple configuration.

The operation of the circuit of the fourth embodiment will be described next. First, the gate voltage of the transistor Q2 is controlled to control the amount of current to the electrode. Thus, as described above, a desired voltage is obtained for the Data (m) for storing data, and the Gate (n) is controlled to temporarily turn on the transistor Q1 and then turn it off, so that charge is stored in the data-signal storing capacitor C1. The predetermined voltage at the storage capacitor C1 is maintained until this state is changed, so that the EL element connected via the electrode continues driving or light emitting.

As in the first embodiment, when an n-type transistor is used for the transistor Q2, the driving circuit serves to set a voltage for the electrode, and when a p-type transistor is used for the transistor Q2, the driving circuit serves to set current for the electrode. In either case, the operation principles are the same.

Here, the anode of the diode Dt is connected to the electrode and the cathode is connected to the gate line Gate (n+1) of a pixel other than the pixel of interest, for example, the gate line Gate (n+1) of an adjacent pixel. Here, the Gate (n+1) is caused to have a conducting voltage of the diode Dt and an ammeter (not shown) connected to the current-source line Is (m) is used to measure current flowing through the electrode. It is preferable that the diode Dt be designed so that a period in which it is turned on is as short as possible during actual use after an EL element is mounted (i.e., so that electricity flows to the EL element (not shown) via the electrode during actual use and current flows from the diode Dt to the Gate (n+1) in only a very short period of time). In this case, it is preferable to use a p-type transistor for the transistor Q1. That is, it is sufficient to satisfy the condition that the diode Dt of the pixel of interest not be turned on even when the gate Gate (n+1) of the transistor Q1 of a pixel adjacent to the pixel of interest is turned off. Specifically, in order to prevent current from flowing to the diode Dt, the cathode side of the diode Dt may be maintained at a potential higher than that of the electrode. In the case of FIG. 9, however, the connection end is the gate line Gate (n+1) adjacent to the pixel of interest. Here, in order to operate the transistor Q1 adjacent to the pixel of interest, the gate line Gate (n+1) needs to be turned on or off independently of the pixel of interest. Thus, restrictions on the circuit configuration exist in the case of FIG. 9.

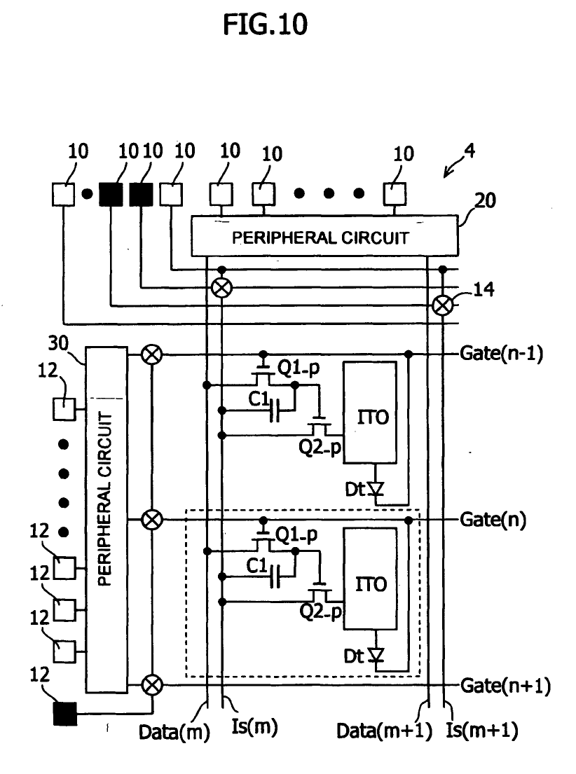

A case in which the anode of the diode Dt is connected to the electrode and the cathode is connected to the gate line Gate (n) of the same pixel as the pixel of interest will be described with reference to FIG. 10. First, the voltage in the gate line Gate (n) of the pixel of interest is caused to go low and the p-type transistor (Q1) and the diode (Dt) are turned on. Subsequently, a desired voltage is obtained for the voltage-signal line Data (m) for storing data for the pixel of interest and the voltage value is used to control the gate of the transistor (Q2).

Here, since the anode of the diode (Dt) is connected to the electrode and the cathode is connected to the Gate (n), current flows to the Gate (n) via the transistor (Q2) and the diode (Dt) in accordance with the voltage value of the Data (m). The voltage of the Gate (n) is controlled so that the diode Dt transmits electricity and an ammeter (not shown) connected to the current-source line Is (m) or the gate line Gate (n) of the pixel of interest is used to measure the current flowing through the electrode (i.e., current flowing through the EL element).

With this arrangement, an electrical characteristic of the transistor (Q2) for driving the electrode of the pixel of interest can be measured based on the voltage determined by the Data (m). This measurement provides an advantage in that, for example, setting at least two setting voltage values for the Data (m) and measuring current flowing after a certain waiting time using an ammeter or charge meter allows detailed measurement of a current characteristic of the transistor (Q2), the characteristic being different from the hold-state characteristic of a pixel of interest. Since this measurement does not use any line of another pixel, the control is simple and loads during the circuit design of elements are reduced.

Here, diode (Dt) is turned on when writing to the pixel of interest is performed. The diode (Dt) can be provided, as a TEG for pixel process-management, on a display apparatus, to be used for evaluation of the display apparatus. A pixel including the test circuit can be used together with a pixel including another test circuit.

It is also preferable that the diode Dt be designed so that a period in which it is turned on is as short as possible during actual use after an EL element is mounted (i.e., so that electricity flows to the EL element (not shown) via the electrode during actual use and current flows from the diode Dt to the Gate (n) in only a very short period of time). In this case, it is preferable to use a p-type transistor for the transistor Q1. That is, it is sufficient to satisfy the condition that the diode Dt of a pixel of interest not be turned on when the Gate (n) of the transistor Q1 of the pixel of interest is turned off. Specifically, in order to permit current to flow to the diode Dt in only a short period of time, the cathode side of the diode Dt may be maintained at a potential higher than that of the electrode, except for the time when the Gate (n) is used. In the case of FIG. 10, the connection end is the gate line Gate (n) of the pixel of interest. Thus, in the case of FIG. 10, restrictions on the circuit configuration exist, as in FIG. 9.

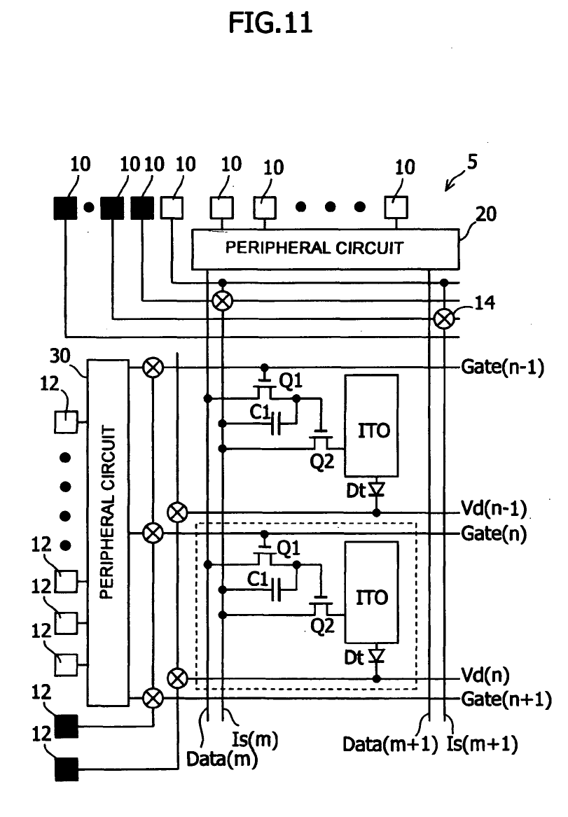

A fifth embodiment of the present invention which eliminates the restrictions on the circuit configuration will be described with reference to FIG. 11. In the fifth embodiment, an additional voltage supply line Vd (n) is added to the fourth embodiment. The cathode of the diode Dt is connected to the additional voltage supply line Vd (n). While the additional line is required, this case provides an advantage in that a restriction on the type of transistor Q1 is eliminated.

For inspection of the pixel driving circuit, it can be evaluated using an ammeter (not shown) connected to the voltage supply line Vd (n) or the current-source line Is (m). In the former case, the voltage supply line Vd (n) is maintained at a high potential to thereby prevent current supplied to the electrode (ITO) from flowing out via the diode Dt.

In this case, with regard to the voltage setting of the data-signal line Data (m), for example, when it is desired to set current flowing through the transistor Q2 to 1 μA, there is a case in which it is predicted that setting the voltage of the Data (m) to 1 V is favorable. In such a case, when the voltage of the Data (m) is set in such a manner, the ammeter connected to the voltage-supply line Vd (n) or the current-source line (Is (m)) can be used to detect the level of current flowing through the transistor Q2 to thereby determine whether or not the current value satisfies the product specifications.

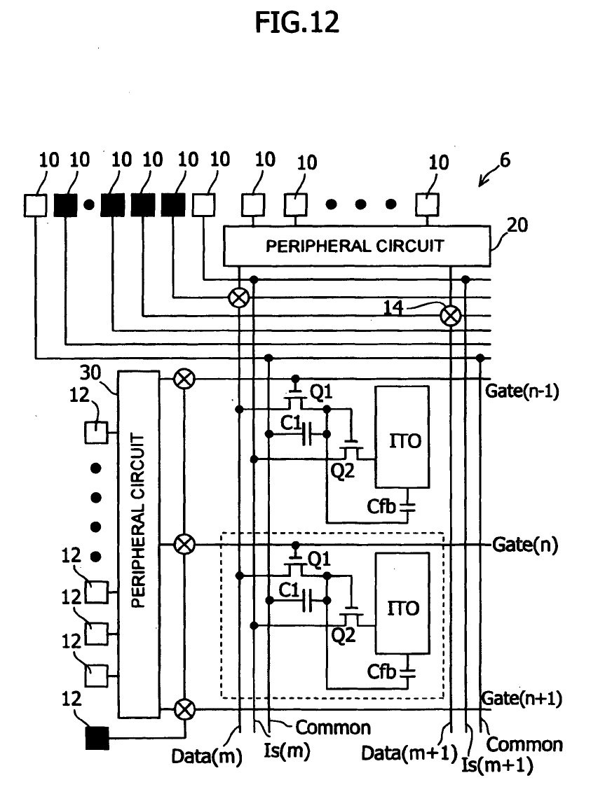

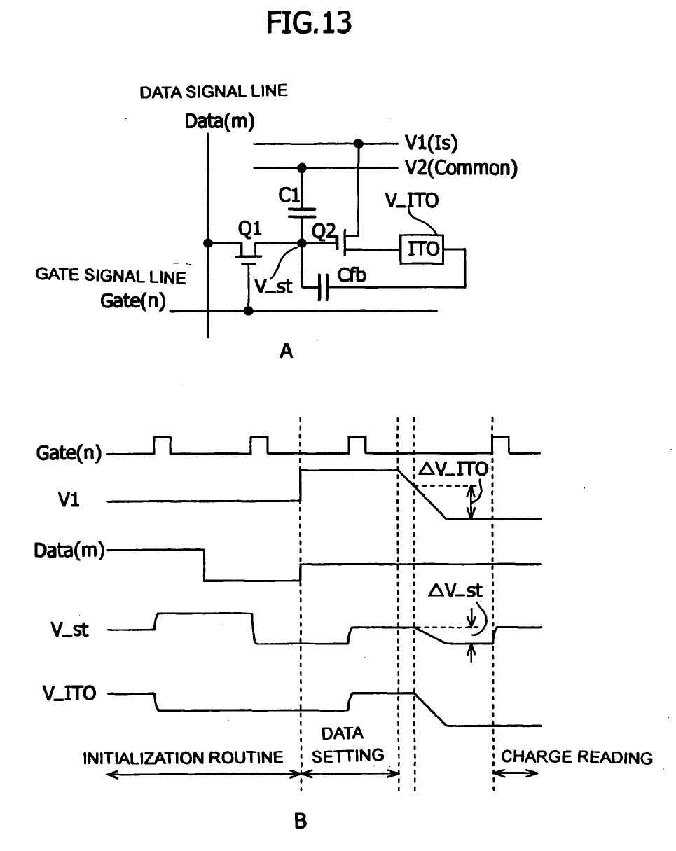

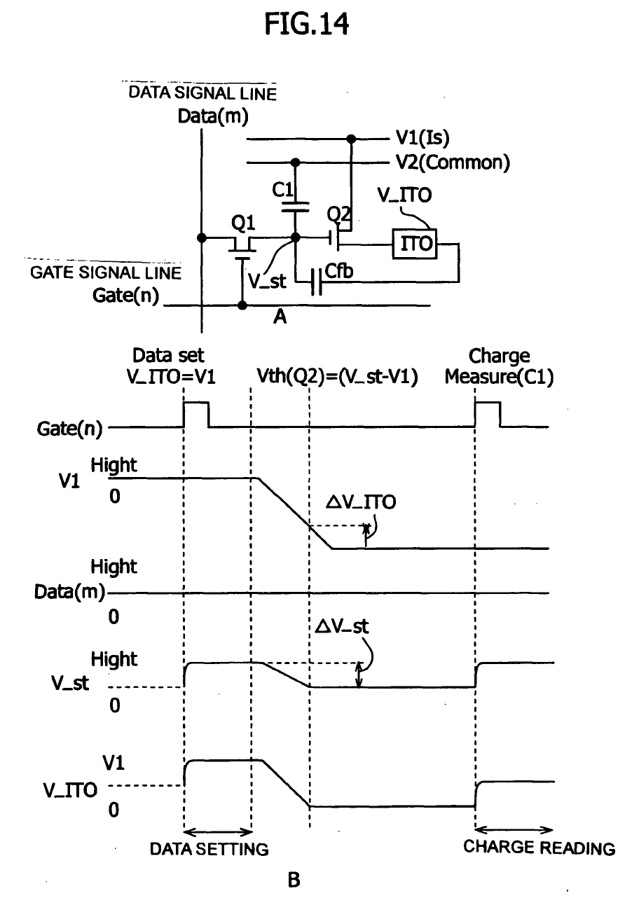

A sixth embodiment of the present invention using load capacitors Cfb will be described next with reference to FIG. 12. In the sixth embodiment, the capacitor Cfb is connected to the electrode and another end of the capacitor Cfb is connected so as to achieve feedback for the gate of the transistor Q2. Further, the storage capacitor C1 for storing a data signal is connected to an additional power-source supply line (Common) that is different from the power-source supply line.

There are two types of operation of the circuit in the sixth embodiment, namely, a voltage-driven type and a current-driven type. Operation principles for the respective cases will be described below.

(Description of Voltage-Driven-Type Operation)

The voltage-driven-type operation will be described with reference to FIG. 13. Here, n-type transistors are used for the transistors Q1 and Q2. First, as an initialization routine, the capacitor Cfb is reset. Specifically, in a state in which a power-source supply line V1 (corresponding to Is shown in FIG. 12) is set to a zero potential, the gate of the transistor Q2 is turned on once and the capacitor Cfb is reset. This is intended to eliminate an adverse effect caused by charge that is inherently present in the capacitor Cfb to thereby perform charge measurement with high accuracy. Next, a current supply voltage V1 is supplied to the transistor Q2. Additionally, the gate of the transistor Q1 is turned on, and the transistor Q2 is turned on by a predetermined voltage supplied from the data-signal line Data (m). Also, after the voltage is applied to the storage capacitor C1, the transistor Q1 is turned off.

This state is maintained over a predetermined period of time, so that V_ITO indicating a voltage at the electrode and a voltage at the capacitor Cfb are saturated into a certain state. In response, the transistor Q2 is also put into an off state. From this state, the voltage V1 is gradually reduced. Here, the voltage V_ITO does not fluctuate until V1 and V_ITO become equal to each other. However, when a difference between V1 and V_st exceeds a threshold voltage Vth of the transistor Q2, i.e., when the voltage V1 becomes lower than V_ITO, the transistor Q2 is put into an on state, and thereafter, the V_ITO decreases, following V1. In this case, in accordance with the decrease in the voltage V_ITO, the capacitor Cfb discharges electricity and thus its voltage decreases. Thus, the voltage V_st at a point between the data-storing capacitors C1 and Cfb decreases in accordance with the decrease in the voltage of the capacitor Cfb. Thereafter, V1 is reduced until V1 reaches a predetermined voltage. This predetermined voltage is determined so that the amount of change ΔV_st of the voltage V_st can easily be obtained.

Obtaining the amount of change ΔV_st of the voltage V_st at this point allows for determination of a characteristic of the driving circuit. Specifically, after a predetermined voltage is reached by the V1 operation, the gate of the transistor Q1 is turned on again by the Gate (n) and the voltage V_st can be measured through the use of an ammeter or charge meter (not shown) connected to the data line Data (m). The amount of charge first stored in the storage capacitor C1 for the data-signal voltage is compared with the amount of charge determined from ΔV_st. When the amount of change in the voltage V_ITO is defined as ΔV_ITO, the amount of measured charge satisfies the relationship of ΔV_st=ΔV_ITO×(Cfb/(C1+Cfb)). Thus, in each pixel, a determination is made as to whether or not an error is within a period range to thereby make it possible to check the operation of the driving circuit for the pixel.

(Description of Current-Driven Type Operation)

The current-driven-type operation will be described with reference to FIG. 14. In this case, p-type transistors are used for the transistors Q1 and Q2. Unlike the voltage-driven type operation described above, the resetting of the capacitor Cfb is unnecessary here. A predetermined voltage is also supplied to a power-source supply line V2 (corresponding to Common shown in FIG. 12). Here, the gate signal line Gate (n) is controlled to turn on the transistor Q1. Applying a predetermined voltage to the data-signal line Data (m) in advance also puts the transistor Q2 into an on state. At this point, the voltage of the V1 (corresponding to the voltage of Is shown in FIG. 12) connected to the source of the transistor Q2 is set to be higher than the voltage of the gate. From this state, the voltage of the power-source supply line V1 (Is) is reduced. The voltage V_ITO of the electrode (ITO electrode) also decreases correspondingly, until the transistor Q2 is turned off. As described above, in this case, current flows out from the storage capacitor C1 to the capacitor Cfb. When the potential of the power-source supply line V1 is reduced to a value less than a voltage (threshold voltage Vth) that turns off the gate potential of the transistor Q2, no charge flows out from the C1. In this state, the transistor Q1 is turned on and an ammeter or charge meter (not shown) connected to the data signal line (Data (m)) is used to measure the amount of charge stored in the storage capacitor C1. Then, a difference between the amount of charge supplied (or written) to the storage capacitor C1 and the amount of charge read is determined for each pixel. Determining whether or not the difference is in a predetermined range makes it possible to check the operation of the driving circuit for the pixel.

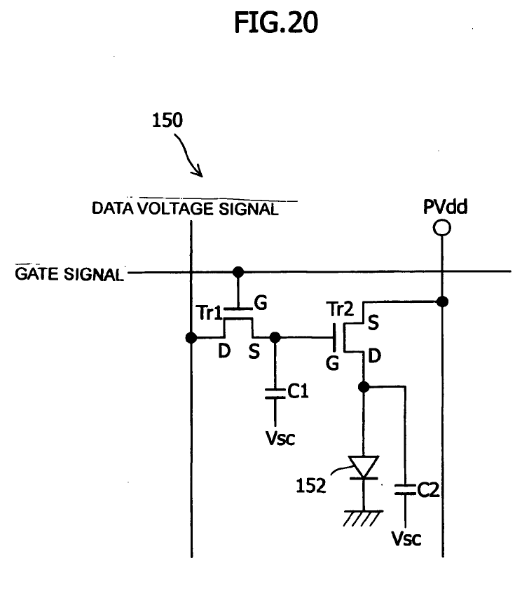

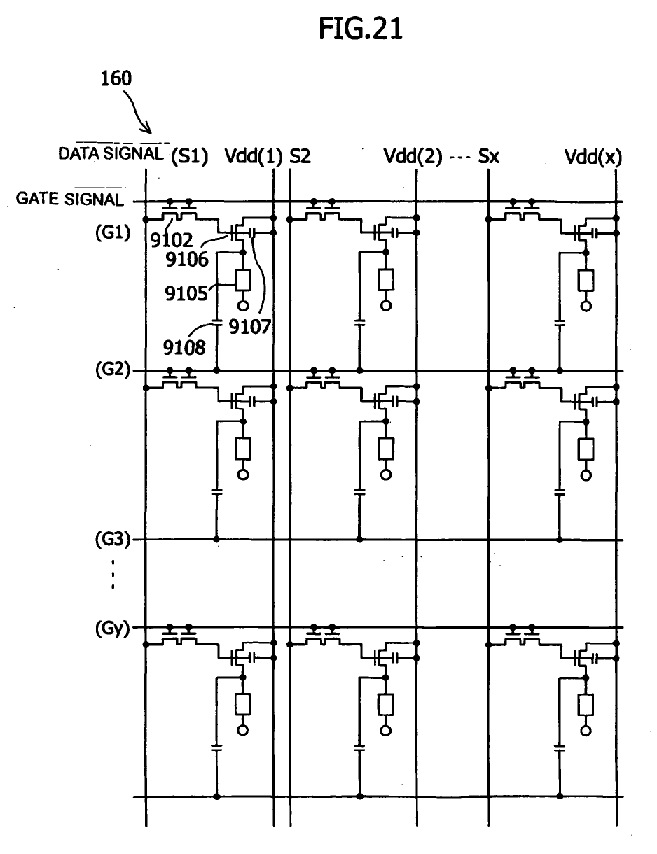

In the sixth embodiment described above, the value of the threshold voltage Vth of the transistor Q2 can be determined by a single measurement operation. Thus, compared to the conventional circuit, the sixth embodiment has an advantage in that the measurement throughput is high. Referring now to FIG. 20, in Patent Document 2, the storage capacitor C1 for data storage is connected to another line (Vsc). In Patent Document 2, as shown in FIG. 20, an n-type transistor may be used as the transistor Tr2, and this Tr2 merely functions as a switch. Consequently, it would be possible to determine only the on state or off state of the transistor Tr2, i.e., determine only whether the transistor Tr2 functions properly or malfunctions. Thus, in order to determine the threshold voltage Vth of the transistor Q2 in the present invention, in Patent Document 2, there is a need to repeat a similar measurement operation multiple times while changing the value of a voltage to be supplied. In Patent Document 3 described above, a capacitance corresponding to the capacitance described above is connected to a neighboring gate line. It is to be noted that even when the capacitance is fed back to the gate terminal of a transistor 9106, the circuit does not operate properly.

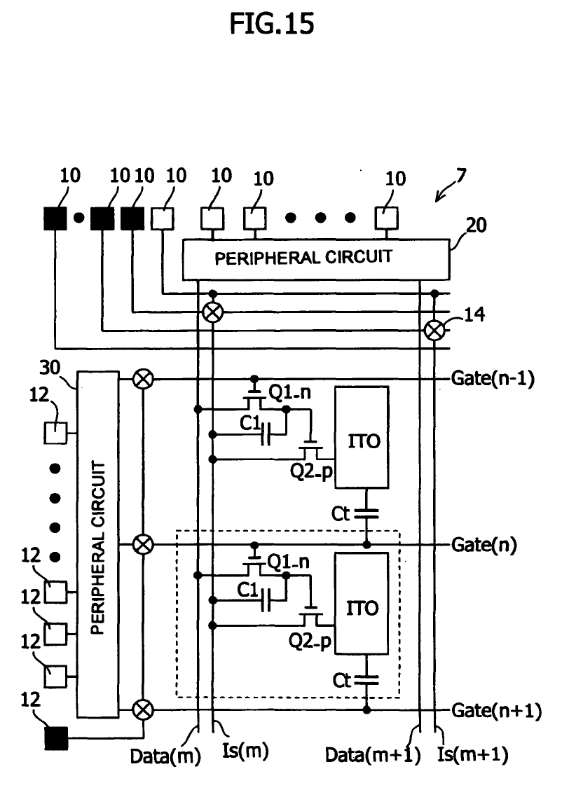

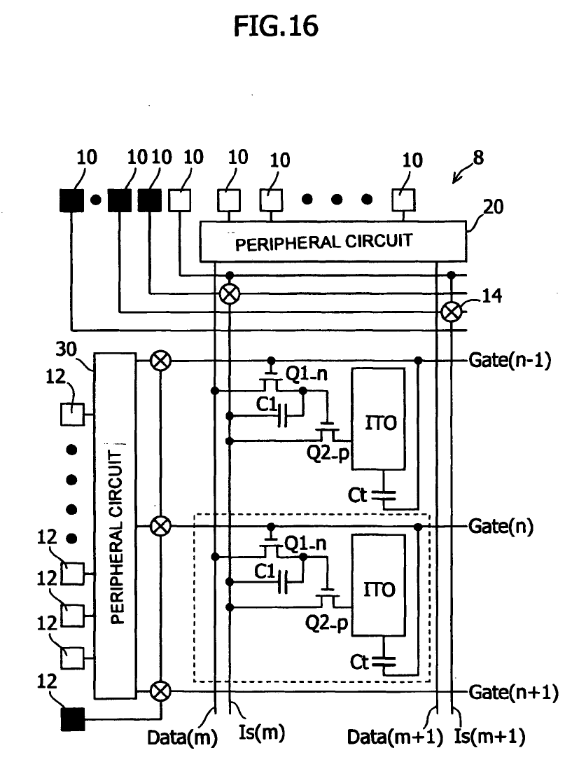

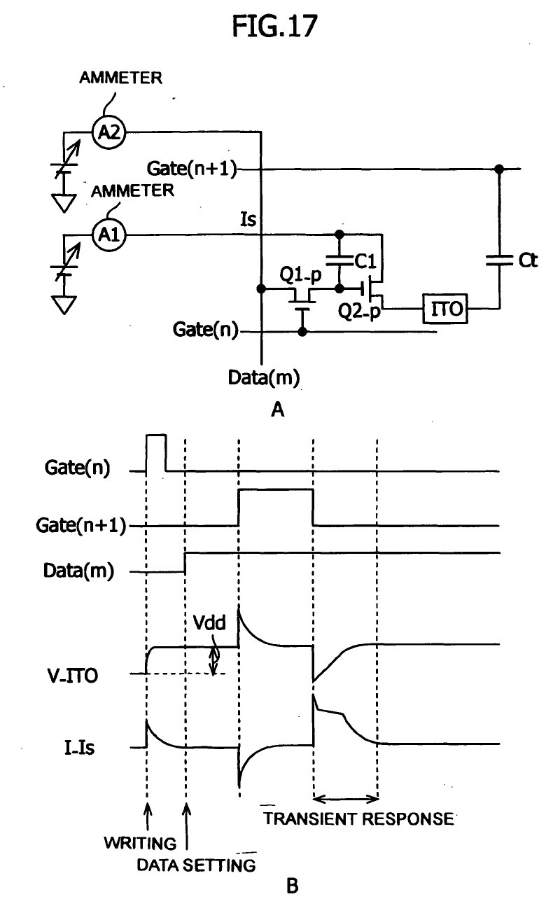

A seventh embodiment of the present invention will be described next. The seventh embodiment relates to a method for determining a transient response of a driving circuit using a capacitor Ct. FIGS. 15 and 16 show the circuit used in this case. The circuit configuration shown in FIG. 15 corresponds to the one in FIG. 1F and is substantially the same as the circuit configuration using the diode shown in FIG. 9. FIG. 16 differs from FIG. 15 in that a connection end of the capacitor Ct is connected to the gate line Gate (n) of a display element to which the capacitor Ct belongs. In this manner, it is preferable that another end of the capacitor Ct connected to the electrode be, for example, (1) the gate line of a display element other than the display element to which that capacitor belongs or (2) the gate line of a display element to which that capacitor belongs. The reason is that those lines always exist in the vicinity of the pixel to drive or control the EL element and thus can be used to intentionally make a change to a voltage. Another connection end of the capacitor Ct connected to the electrode is not limited to those examples, and thus the connection end is connectable to another line, for example, a pixel electrode or the like.

In such a circuit configuration, during the occurrence of a transient response, measuring transient-response current, the amount of charge stored in the capacitor, and so on by using an ammeter or the like connected to the line Is makes it possible to evaluate a transient response of a voltage V_ITO of the electrode (ITO) of each pixel.

### Description of Operation of Seventh Embodiment

(1) A case in which the capacitor Ct is connected to the gate line of a display element other than a display element to which the capacitor belongs.

A description is given with reference to FIG. 17. First, the gate line in question (Gate (n)) is controlled to cause charge from the data signal line (Data (m)) to be stored in the storage capacitor C1, and writing and data setting are performed. Next, a voltage is supplied to the neighboring gate line (Gate (n+1)) to store charge in the capacitor Ct. When the operation is put into a steady state after a predetermined time elapses, the potential at the ITO electrode reaches a certain value (Vdd). The voltage in the neighboring gate line (Gate (n+1)) is reduced to a predetermined voltage to generate a transient response. During the occurrence of the transient response, an ammeter A1 connected to the current supply line Is (corresponding to Is (m)) shown in FIG. 15) is used to measure transient response current (I_Is) in a pixel to be inspected. In this manner, it is possible to evaluate the current-driving capability of the pixel-driving circuit for each pixel. In this embodiment, p-type transistors are used as the transistors Q1 and Q2 shown in FIG. 17.
(2) A case in which the capacitor Ct is connected to the gate line of a display element to which the capacitor belongs.

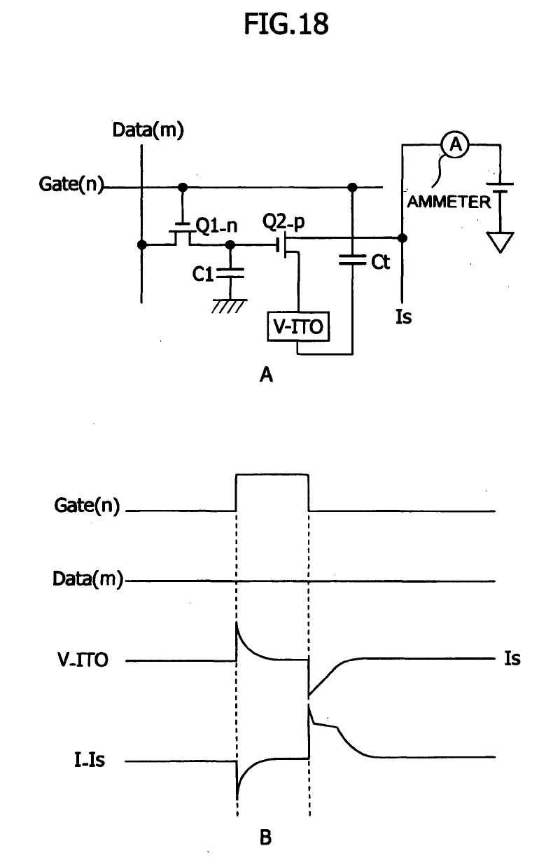

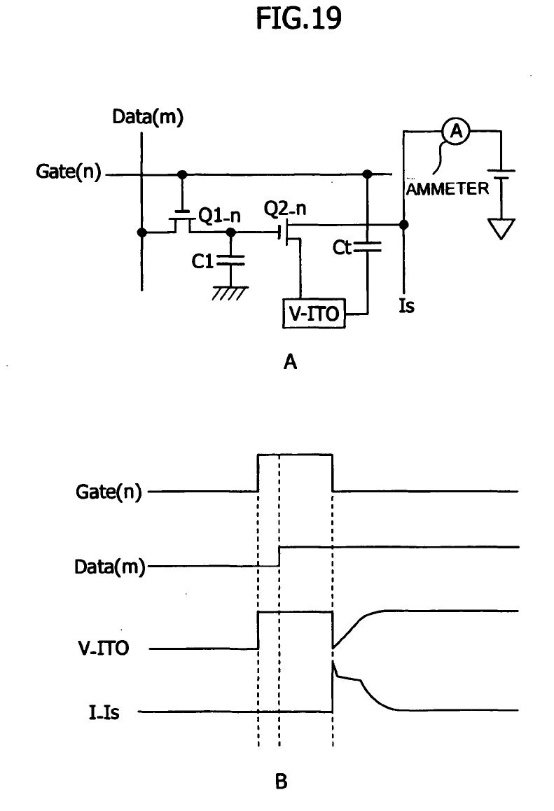

A description is given with reference to FIG. 18. In this case, the voltage of the gate line (Gate (n)) of the display element in question is changed to generate a transient response in the same manner as case (1). By the time the transient response settles, the transient-response current at this point is measured with the ammeter connected to the current supply line Is (corresponding to Is (m) shown in FIG. 16). Here, when the capacitor Ct is connected to the gate line in question, an n-type transistor (Q1_n) is used as the transistor Q1 and a p-type transistor (Q2_p) is used as the transistor Q2 in FIG. 18, and n-type transistors (Q1_n and Q2_n) are used as transistors Q1 and Q2 in FIG. 19.

Here, the case of FIG. 18 is described first. First, the voltage of the gate line in question (Gate (n)) is controlled to turn on the transistor Q1, so that charge is store in the Ct. Subsequently, the voltage (V_ITO) at the electrode (ITO electrode) is put into a steady state after a predetermined time elapses, and then the voltage of the gate line in question (Gate (n)) is reduced to a predetermined voltage. As in the case described above, the ammeter connected to the current supply line Is is used to allow measurement of the transient response (I_Is) of charge stored in the capacitor Ct. Here, the predetermined voltage needs to cause a potential difference to a degree at which the transient response is generated.

Next, a case in which n-type transistors are used as the transistors Q1 and Q2 will be described with reference to FIG. 19. First, the voltage of the gate line in question (Gate (n)) is controlled to turn on the transistor Q1, so that charge is stored in the capacitor Ct. Subsequently, the voltage (V_ITO) at the electrode is put into a steady state after a predetermined time elapses, and then the voltage of the data-signal line in question (Data (m)) is increased to a predetermined voltage. Thereafter, after a predetermined time elapses, the voltage of the gate line in question (Gate (n)) is reduced to a predetermined voltage. As in the case described above, the ammeter connected to the current supply line Is is used to allow measurement of the transient response (I_Is) of charge stored in the capacitor Ct.

The embodiment described above provides an advantage in that even the current-driving capability can be evaluated through the measurement of the transient-response current. It is to be noted that the operation described above cannot be executed by the circuit disclosed in Patent document 2.

It is preferable that, in practice, elements added to the various electrodes described in the embodiments be turned on when the driving circuit is evaluated, and the elements be turned off when used as a product. This is because there is a risk that sufficient power for light-emitting or driving of the EL elements cannot be supplied. It is also preferable to achieve a connection with an existing line if possible rather than adding an additional line. This is because an increase in the number of lines can be prevented.

Although the switches for on/off turning are shown in the figures illustrated above, it is to be noted that such switches are not essential elements in the present invention. This is because measurement resolution improvement and parallel processing can also be achieved by increasing the number of lines and separating the pixels instead of providing the switches. Similarly, it is to be noted that the peripheral circuits are not particularly essential elements for evaluation in the present invention.

In the embodiments described above, ITO (indium tin oxide) is used for the electrodes for driving the organic EL elements. This ITO has a transparent optical property in the visible light region and is used for transparent electrodes in liquid crystal displays (LCDs) requiring a backlight. However, since an organic EL element emits light by itself, the ITO used in the present invention is used for electrodes for driving the organic EL element pixels but is not particularly limited thereto. For example, electrically conductive metal or the like can also be used instead of ITO. It is also to be noted that ITO can be used for the cathodes of the organic EL elements.

With the arrangement described above, according to the present invention, it is possible to evaluate a direct-current characteristic, a transient response characteristic, or the like of the driving circuits for the organic El elements, without using a special apparatus. As a result, it is possible to perform evaluation according to an actual usage state, with high accuracy and low cost.

The scope protected by the present invention is not limited to the embodiments described above and also extends to the invention described in the claims and equivalents thereto.

1. An active-matrix display apparatus, comprising:
a substrate;
an electrode for provision of a display element included in each of a plurality of pixels provided on the substrate;
a first transistor that is connected to the electrode and a first current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate of the second transistor;
a storage capacitor connected to the current-source line and the gate of the first transistor, for storing a voltage signal supplied from the data-storing signal line via the second transistor, while the second transistor is in an on state; and
a third transistor that has a source and a drain connected to the electrode and a gate signal line for a display element other than said display element, and that has a gate controlled such that current flowing from the first transistor to the electrode is led to the gate signal line for the other display element.

2. The display apparatus according to claim 1, wherein the gate of the third transistor is connected to a second current-source line for the display element other than the display element to thereby perform control such that the gate is put into an on state or off state.

3. The display apparatus according to claim 1, wherein the gate of the third transistor is connected to the gate signal line for the other display element to thereby perform control such that the gate is put into an on state or an off state.

4. An active-matrix display apparatus, comprising:
a substrate;
an electrode for provision of a display element included in each of a plurality of pixels provided on the substrate;
a first transistor that is connected to the electrode and a first current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to the gate the second transistor;
a storage capacitor connected to the current-source line and the gate of the first transistor for storing a voltage signal supplied from the data-storing signal line via the second transistor, while the second transistor is in an on state; and
a third transistor that has a source and a drain connected to the electrode and the gate signal line, and that has a gate put into an on state or an off state by changing a potential of a gate signal line for a display element other than said display element, so that current flowing from the first transistor to the electrode is led to the gate signal line.

5. The display apparatus according to claim 1, wherein the display element is an organic EL element.

6. The display apparatus according to claims 1, wherein the gate of the third transistor is connected to a power-source supply line that is additionally provided.

7. An active-matrix display apparatus, comprising:
a substrate;
an electrode for provision of a display element included in each of a plurality of pixels provided on the substrate;
a first transistor that is connected to the electrode and a first current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate thereof;
a storage capacitor connected to the current-source line and the gate of the first transistor for storing a voltage signal supplied from the data-storing signal line via the second transistor, while the second transistor is in an on state; and
a third transistor that has a source and a drain connected to the electrode and an additionally-provided power-source supply line and whose gate is controlled such that current flowing from the first transistor to the electrode is led to the additionally-provided power-source supply line.

8. The display apparatus according to claim 1, wherein the third transistor is p-type.

9. The display apparatus according to claim 1, wherein a line from the third transistor is connected to a peripheral circuit for simultaneously controlling two or more of the display elements when the display apparatus is in an operation state, and the third transistors are sequentially switched via the peripheral circuit.

10. A method for inspecting each display element of an active-matrix display apparatus comprising a substrate; an electrode for provision of a display element included in each of a plurality of pixels provided on the substrate; a first transistor that is connected to the electrode and a first current-source line and that determines on or off state of the display element by using a voltage applied to a gate thereof; a second transistor that is connected to the gate of the first transistor and a data-storing signal line and that determines a gate voltage of the first transistor by using a voltage in a gate signal line connected to a gate of the second transistor; a storage capacitor connected to the current-source line and the gate of the first transistor, for storing a voltage signal supplied from the data-storing signal line via the second transistor, while the second transistor is in an on state; and a third transistor that has a source and a drain connected to the electrode and a gate signal line for a display element other than said display element, and that has a gate controlled such that current flowing from the first transistor to the electrode is led to the gate signal line for the other display element, the method comprising the steps of:
storing charge into the storage capacitor by controlling a gate voltage of the second transistor;
controlling the gate of the third transistor by changing a potential of a first line for a display element other than the display element to be inspected; and
measuring an amount of charge or current flowing from the electrode via the third transistor by using a measuring unit connected to the first current-source line for the display element to be inspected.

11. A display apparatus, comprising:
a substrate;
an electrode for provision of a display element included in each of a plurality of pixels provided on the substrate;
a first transistor that is connected to the electrode and a current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate of the second transistor;
a storage capacitor connected to the current-source line and the gate of the first transistor for storing a signal supplied from the data-storing signal line via the second transistor, while the second transistor is in an on state; and
a diode connected to the electrode and to a gate signal line for a display element other than the display element.

12. The display apparatus according to claim 11, wherein the display element is an organic EL element.

13. A display apparatus, comprising:
a substrate;
an electrode for provision of a display element included in each of a plurality of pixels provided on the substrate;
a first transistor that is connected to the electrode and a current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate the second transistor;
a storage capacitor connected to the current-source line and the gate of the first transistor for storing a signal supplied from the data-storing signal line via the second transistor, while the second transistor is in an on state; and
a diode connected to the electrode and to an additionally-provided current releasing line.

14. A method for inspecting each pixel of the active a display apparatus, comprising: a substrate; an electrode for provision of a display element included in each of a plurality of pixels provided on the substrate; a first transistor that is connected to the electrode and a current-source line and that determines on or off state of the display element by using a voltage applied to a gate thereof; a second transistor that is connected to the gate of the first transistor and a data-storing signal line and that determines a gate voltage of the first transistor by using a voltage in a gate signal line connected to a gate of the second transistor; a storage capacitor connected to the current-source line and the gate of the first transistor for storing a signal supplied from the data-storing signal line via the second transistor, while the second transistor is in an on state; and a diode connected to the electrode and to a gate signal line for a display element other than the display element, the method comprising the steps of:
storing charge into the storage capacitor by controlling the gate of the second transistor; and
measuring an amount of charge or current flowing from the electrode via the diode, by changing a potential of a first line for a display element other than the display element to be inspected and using a measuring unit connected to a second line for the display element other than the display element to be inspected.

15. An active-matrix display apparatus, each pixel included in the display apparatus comprising:
an electrode connected to a display element for the pixel;
a first transistor connected to the electrode and to a first line for the pixel;
a second transistor connected to a gate of the first transistor and to a data-storing signal line for supplying a voltage signal;
a storage capacitor connected to the gate of the first transistor and to a second line for the pixel, and
a load capacitor connected to the electrode and the gate of the first transistor such that charge is accumulated by current flowing from the first transistor to the electrode.

16. The display apparatus according to claim 15, wherein the display element is an organic EL element.

17. A method for inspecting each pixel of the active an active-matrix display apparatus, each pixel included in the display apparatus comprising an electrode connected to a display element for the pixel; a first transistor connected to the electrode and to a first line for the pixel; a second transistor connected to a gate of the first transistor and to a data-storing signal line for supplying a voltage signal; a storage capacitor connected to the gate of the first transistor and to a second line for the pixel and a load capacitor connected to the electrode and the gate of the first transistor such that charge is accumulated by current flowing from the first transistor to the electrode, the method comprising the steps of:
supplying a first voltage to the first transistor;
storing charge into the storage capacitor and the load capacitor by temporarily turning on and turning off the second transistor through control of the gate signal line connected to the gate of the second transistor to thereby apply a voltage of the data-storing signal line to the gate of the first transistor;
reducing the first voltage to a predetermined voltage; and
measuring an amount of charge stored in the storage capacitor by turning on the second transistor and using a charge measuring unit connected to the data-storing signal line.

18. The method according to claim 17, wherein in the step of reducing the first voltage, the first voltage is reduced to a predetermined voltage that is lower than the voltage of the electrode in the step of storing the charge.

19. The method according to claim 17, further comprising a step of pre-resetting the amount of charge stored in the storage capacitor, prior to the step of supplying the first voltage to the first transistor.

20. The method according to claim 17, wherein in the step of reducing the first voltage, the first voltage is reduced until the first transistor is turned off by a threshold voltage of the first transistor.

21. An active-matrix display apparatus, comprising:
a substrate;
an electrode for provision of a display element included in each of a plurality of pixels provided on the substrate;
a first transistor connected to the electrode and to a current-source line;
a second transistor connected to a gate of the first transistor and to a data-storing signal line with a gate signal line being connected to a gate thereof;
a storage capacitor connected to the gate of the first transistor and to the current-source line; and
a load capacitor connected to the electrode and to the gate of the second transistor of another display element such that charge is accumulated by current flowing when the first transistor is turned on.

22. An active-matrix display apparatus, comprising:
a substrate;
an electrode for provision of a display element included in each of a plurality of pixels provided on the substrate;
a first transistor connected to the electrode and to a current-source line;
a second transistor connected to a gate of the first transistor and to a data-storing signal line with a gate signal line being connected to a gate thereof;
a storage capacitor connected to the gate of the first transistor and to the current-source line; and
a load capacitor connected to the electrode and to the gate of the second transistor of the same display element and connected to the gate signal line such that charge is accumulated by current flowing when the first transistor is on.

23. The display apparatus according to claim 22, wherein the display element is an organic EL element.

24. A method for inspecting each display element an active-matrix display apparatus comprising a substrate; an electrode for Provision of a display element included in each of a plurality of pixels provided on the substrate; a first transistor connected to the electrode and to a current-source line; a second transistor connected to a gate of the first transistor and to a data-storing signal line with a gate signal line being connected to a gate thereof; a storage capacitor connected to the gate of the first transistor and to the current-source line; and a load capacitor connected to the electrode and to the gate of the second transistor of the same display element and connected to the gate signal line such that charge is accumulated by current flowing when the first transistor is on, the method comprising the steps of:
storing charge into the storage capacitor by controlling the gate of the second transistor; and
measuring an amount of charge or current flowing from the electrode by changing a potential of a gate signal line for a display element other than the display element to be inspected and using a measuring unit connected to the current-source line for the display element to be inspected.

25. The active-matrix display apparatus according to claim 1, wherein the other display element is adjacent to the display element to be inspected.

26. (canceled)

27. An active-matrix display apparatus, comprising:
a substrate;
an electrode for provision of a display element included in each of a plurality of pixels provided on the substrate;
a first transistor that is connected to the electrode and a first current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate thereof; and
a third transistor that has a drain connected to the electrode and that has a source and a gate connected to the gate signal line for the display element, so that current flowing from the first transistor to the electrode is led to the gate signal line for the display element.

28. An active-matrix display apparatus, comprising:
a substrate;
an electrode for provision of a display element included in each of a plurality of pixels provided on the substrate;
a first transistor that is connected to the electrode and a current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate the second transistor; and
a diode connected to the electrode and to the gate signal line for the display element.

29. A method for inspecting each display element of an active-matrix display apparatus comprising a substrate; an electrode for provision of a display element included in each of a plurality of pixels provided on the substrate; a first transistor that is connected to the electrode and a first current-source line and that determines on or off state of the display element by using a voltage applied to a gate thereof; a second transistor that is connected to the gate of the first transistor and a data-storing signal line and that determines a gate voltage of the first transistor by using a voltage in a gate signal line connected to a gate thereof; and a third transistor that has a drain connected to the electrode and that has a source and a gate connected to the gate signal line for the display element, so that current flowing from the first transistor to the electrode is led to the gate signal line for the display element, the method comprising the steps of:
controlling a gate voltage of the second transistor by changing a potential of the gate signal line for the display element to be inspected, supplying a voltage determined by the data-storing signal line to the gate of the first transistor, and controlling the gate of the third transistor or the diode; and
measuring an amount of charge or current flowing from the electrode via the third transistor or the diode, by using a measuring unit connected to the gate signal line or the first current-source line.

30. An active-matrix display apparatus, comprising:
a substrate;
an electrode for provision of a display element included in each of a plurality of pixels provided on the substrate;
a first transistor that is connected to the electrode and a first current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate thereof;
a third transistor connected to the electrode that has a gate and a drain connected to a gate line for a display element other than said display element and that has a gate controlled such that current flowing from the first transistor to the electrode is led to a gate signal line for the other display element.

31. An active-matrix display apparatus, comprising:
a substrate;
an electrode for provision of a display element included in each of a plurality of pixels provided on the substrate;
a first transistor that is connected to the electrode and a first current-source line and that determines on or off state of the display element by using a voltage applied to a gate thereof;
a second transistor that is connected to the gate of the first transistor and a data-storing signal line and that determines a gate voltage of the first transistor by using a voltage in a gate signal line connected to a gate the second transistor;
a third transistor connected to the electrode, which has a gate and a drain connected to a gate line for a display element other than said display element and to a gate line for the display element and which has a gate controlled such that current flowing from the first transistor to the electrode is led to a gate signal line for the display element.

32. A method for inspecting each display element of an active-matrix display apparatus comprising a substrate: an electrode for provision of a display element included in each of a plurality of pixels provided on the substrate; a first transistor that is connected to the electrode and a first current-source line and that determines on or off state of the display element by using a voltage applied to a gate thereof; a second transistor that is connected to the gate of the first transistor and a data-storing signal line and that determines a gate voltage of the first transistor by using a voltage in a gate signal line connected to a gate thereof; a third transistor connected to the electrode that has a gate and a drain connected to a gate line for a display element other than said display element and that has a gate controlled such that current flowing from the first transistor to the electrode is led to a gate signal line for the other display element, the method comprising the steps of:
controlling a gate voltage of the second transistor by changing a potential of the gate signal line for the display element to be inspected, supplying a voltage determined by the data-storing signal line to the gate of the first transistor, and controlling the gate of the third transistor; and
measuring current flowing from the electrode via the third transistor by using a measuring unit connected to the first current-source line for the display element to be inspected or to the gate signal line for the display element other than the display element to be inspected.
